(19) United States
(12) Patent Application Publication
(10) Pub. No.: US 2002/0189902 A1
(43) Pub. Date: Dec. 19, 2002

(54) Protective carrying attachment for ladders

(76) Inventor: John R. Nelson, Miami, FL (US)

Correspondence Address: JOHN R. NELSON, 13932 SW 52 TERRACE, MIAMI, FL, 33175, US

(21) Appl. No.: 09/880,620

(22) Filed: Jun. 13, 2001

(51) Int. Cl. E06C 5/32

(52) U.S. Cl. 182/129

(57) ABSTRACT

An article of padding which attaches to a ladder to facilitate carrying the ladder by a person. This invention is a channel member which attaches to the rail of the ladder at a point where the ladder would rest on the shoulder. The channel member is of suitable material to snap on to the rail of the ladder and remain in place indefinitely. The channel member may have foam rubber or similar padding material affixed to its surfaces. The channel member may be notched to accommodate exiting hardware on some ladders.

### FIELD OF INVENTION

This invention relates to an article of padding which attaches to a ladder to facilitate carrying the ladder by a person.

### BACKGROUND

Prior Art

Presently ladders are manufactured using fiberglass and/or aluminum members. These ladders have a U-shaped channel member for the rail of the ladder. A problem arises in the routine task of carrying the ladder.

Ladders are commonly carried horizontally, with the rail resting on the shoulder. The problem occurs because the edges of the rail concentrate pressure on the neck and shoulder causing pain.

Several inventors have addressed this problem: U.S. Pat. Nos. 5,207,364 to Johnson (1993) and 6,189,752 to Perry (2001) disclose complex ladder cushioning devices. In both devices, the cushion element is rather bulky and would likely interfere with the normal use of the ladder. Therefore, they would have to be removed and reattached frequently. In both devices, the means of attachment would add to their cost and increase the likelihood of broken or missing parts.

U.S. Pat. No. 5,058,789 to Piper (1991) discloses a channel member similar to my present invention but with a distinct difference. Piper's invention attaches to the flat side of the ladder rail, while my invention attaches to the open side of the rail. Additionally, Piper employs a foam pad to hold the channel member in place, while my invention is intended to snap on to the ladder rail. Furthermore, Piper's invention does not provide a cushion when the edges of the rail rest on the shoulder.

### OBJECTS AND ADVANTAGES

Several objects and advantages of the present invention are:

1. to provide an article of padding to facilitate carrying a ladder.

(a) which does not interfere with the normal use of the ladder.

(b) which is easily attachable and removable.

(c) which can be left on the ladder indefinitely, if preferred

(d) which may be permanently affixed to the ladder, if preferred.

(e) which may be notched to accommodate existing hardware on the ladder.

(f) which is durable and weather resistant.

Further objects and advantages will become apparent from the ensuing description and drawings.

### DESCRIPTION

This invention is a channel member which attaches to the open side of the ladder rail at the point where the ladder would rest on the shoulder. This provides a flat surface which distributes the weight of the ladder on the shoulder, thereby reducing pain when carrying the ladder. The channel member is of a material suitable to snap on to the ladder rail and remain in place.

The channel member may have foam rubber or similar cushion material affixed to its surface. The channel material affixed to its surface. The channel member may be notched to accommodate existing hardware on some ladders.

### DRAWINGS

FIG. 1 shows a typical embodiment of the invention. This is a channel member of resilient plastic or similar material whose inside dimension conforms to the outside dimension of the ladder rail.

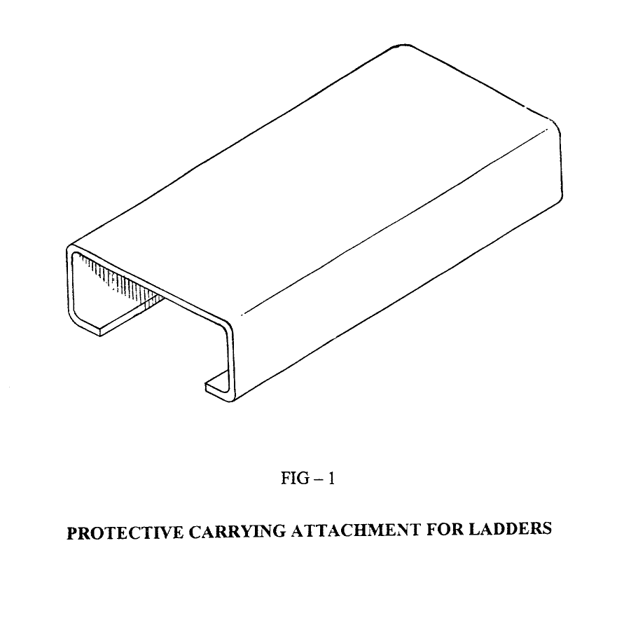

FIG. 2 shows the invention with cushion material affixed.

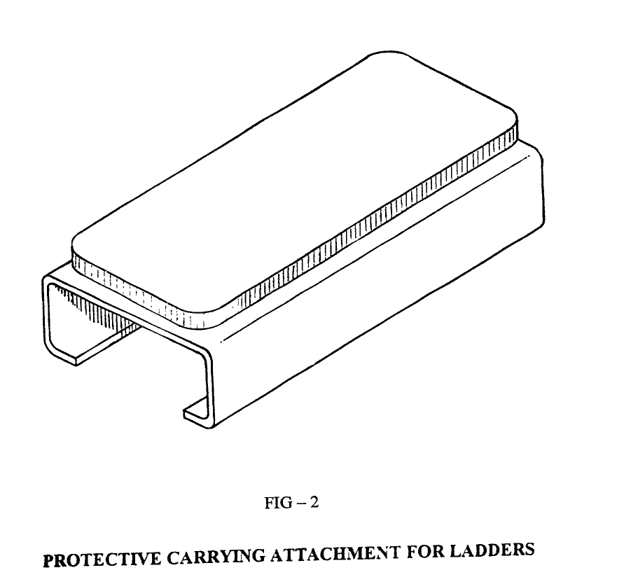

FIG. 3 shows the invention having a notch on one side.

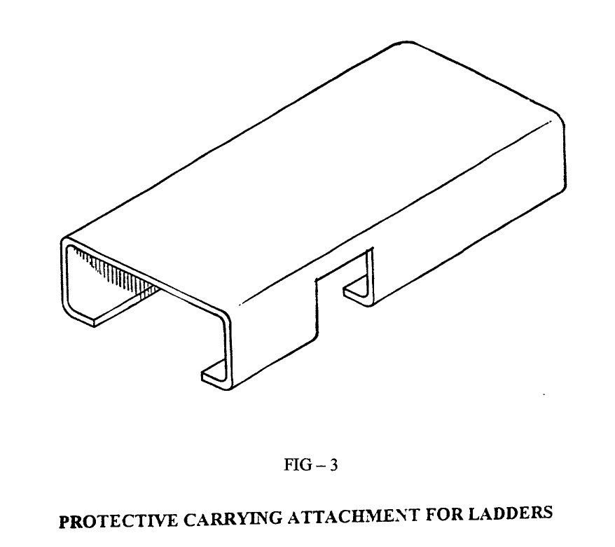

### OPERATION

The protective carrying attachment simply snaps on to the open side of the ladder rail. It may be removed and reattached many times, or it may be left on the ladder indefinitely. It may be permanently affixed to the ladder using PVC glue or similar glue. It may be notched as part of the original manufacture, or in the field using a hacksaw or heavy shears. For longer ladders where two persons carry the ladder, two protective carrying attachments may be used.

### SUMMARY, RAMIFICATIONS, SCOPE

In summary, the protective carrying attachment will be durable and light weight. It will be easy to attach or remove and will not interfere with the normal use of the ladder. It will be inexpensive to manufacture and may be made in different colors to match those of existing ladders. It will be easy to modify in the field if necessary. Moreover, it will greatly reduce the discomfort experienced when carrying a ladder.

Although the description above contains many specifics, these should not be construed as limiting the scope of the invention but as merely providing examples of some of the presently preferred embodiments of this invention.

Thus, the scope of the invention should be determined by the appended claims and their legal equivalents, rather than by the examples given.

1. An article which attaches to a ladder to absorb pressure to the body when said ladder is held or carried by a person, comprising a channel member of resilient, durable material.
(a) The article of claim 1 including a padding material affixed to any or all of its surfaces.
(b) The article of claim 1 having one or more notches in any or all of its sides.
